(19) United States
(12) Patent Application Publication
(10) Pub. No.: US 2013/0023234 A1
(43) Pub. Date: Jan. 24, 2013

(54) SYSTEMS AND METHODS FOR PROVIDING MISLEAD INFORMATION TO INTRUDERS WHEN INTRUSION OCCUR

(71) Applicant: Tai Cheung POON, Hong Kong (HK)

(72) Inventor: Tai Cheung POON, Hong Kong (HK)

(21) Appl. No.: 13/185,776

(22) Filed: Jul. 19, 2011

(51) Int. Cl. H04W 12/02

(52) U.S. Cl. 455/411

(57) ABSTRACT

Systems and methods are provided to mislead information to intruders when intrusions occur. According to one embodiment, a system is provided to prevent intruders from accessing confidential information stored in a phone. In the embodiment, when an intruder is found approaching to the phone, the system is configured to perform security measures. Further, the embodiment captures information with regards to identities of the intruder. Moreover, information is captured with regards to activities carried out by the intruder.

### FIELD OF THE INVENTION

The invention is generally related to methods and systems for preventing unauthorized access to phones. Specifically, and without limitation, this invention relates to misleading information to intruders when intrusions occur. Upon detection, this invention may be configured to execute a method, including deleting the context information of messages currently stored in the phone; and creating a set of new messages whose content is completely unrelated to the deleted messages so that the intruder would not be suspicious about the enablement of the security features when an empty message folder is found.

### BACKGROUND OF THE INVENTION

Phones, in particular wireless phones, are essential in our daily lives. For example, parents use phones to make personal phone calls with their children. Besides from using phones to make voice communications, phones can be used for data communications. As another example, phones can be used by students to check emails regarding the work assigned by their teachers. In yet another example, telephone carriers often send text messages to their clients over phone to notify the clients with products updates and other information that are essential in the carriers' product offerings. However, after phone users make a call or receive information from other parties, the phone users usually retain information regarding the content of the call or received content. Such information is often stored in the phones. Therefore, phones contain plenty of information. Interestingly, some of the information may contain highly confidential. Disadvantageously, the stored information may be harmful to the phone owners, if others gain access over the phones. Phone owners, therefore, may not have total control over their phones. As a result, phones can become vulnerable and may become less dependable. In view of the foregoing, to avoid phone content being read by intruders, there is a need to introduce security measure to control how phone content can be read, when the content should be read, where the content should be read, and how the content should be read. There is a need to monitor the identities of the intruders. There is also a need to monitor the activities carried out by the intruders. There is also a need to perform the monitoring activities without letting the intruders know that they are being monitored. In addition, there is a need to detect whether an intruder is approaching the phone before any physical contact is made by the intruder.

### SUMMARY OF THE INVENTION

A phone configured to provide mislead information to intruders is provided. Consistent with embodiments of this invention, a phone is provided that includes a fingerprint identifier located on a dial pad of the phone, wherein the dial pad includes an infrared transceiver that wirelessly detects whether a user's finger is approaching to the phone by temperature and distance of the user, the fingerprint identifier configured to keep track of fingerprints of the user when the user's finger is about to touch the dial pad; a fingerprint identifier located on a control of the phone, wherein the control includes an infrared transceiver that wirelessly detects whether the user's finger is approaching to the phone by temperature and distance of the user, the fingerprint identifier configured to keep track of frequency of attempt access by the user when the user's finger is about to touch the control; a location detector in the phone, wherein the location detector detects whether the phone should be entered to a secured mode by location; a camera on the phone, wherein the camera identifies the intruders; a processor in the phone; and a memory in the phone storing instructions that cause the processor to execute a method.

According to embodiments of the present invention, the inventive method comprises as part of initialization, defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone, performing security measures, including; protecting confidential information from the intruder, wherein the confidential information includes the content information of messages currently stored in the phone, the context information of messages currently stored in the phone, the specific content information currently stored in the phone, and the specific context information currently stored in the phone; capturing information with regards to identities of the intruder; and capturing information with regards to activities by the intruder; and when the phone is in a state that is considered safe by the owner, releasing the confidential information so that the owner is capable to re-access the confidential information, the state including when the intruder is found approaching away from the phone; when the phone has been moved to a safe location; and when the current time has reached to a time considered as safe by the owner.

Alternatively, the method may comprise, as part of initialization, defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone, performing security measures, including; protecting confidential information from the intruder, wherein the confidential information includes the content information of messages currently stored in the phone, the context information of messages currently stored in the phone, the specific content information currently stored in the phone, and the specific context information currently stored in the phone, protections including swapping the specific content information of messages currently stored in the phone with the corresponding mislead information so that the intruder would instead read the mislead information; swapping the specific context information of messages currently stored in the phone with the corresponding mislead information so that the intruder would read the mislead information instead; capturing information with regards to identities of the intruder; and capturing information with regards to activities by the intruder; when the phone is in a state that is considered safe by the owner, releasing the confidential information so that the owner is capable to re-access the confidential information, the state including when the intruder is found approaching away from the phone; when the phone has been moved to a safe location; and when the current time has reached to a time considered as safe by the owner.

The phone may further include defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone based on detections by the fingerprint identifier located on a dial pad of the phone, the fingerprint identifier located on a control of the phone and the location detector, performing security measures, including; protecting confidential information from the intruder, wherein the confidential information includes the content information of messages currently stored in the phone, the context information of messages currently stored in the phone, the specific content information currently stored in the phone, and the specific context information currently stored in the phone, protections including swapping the i specific content information of messages currently stored in the phone with the corresponding mislead information so that the intruder would instead read the mislead information; swapping the specific context information of messages currently stored in the phone with the corresponding mislead information so that the intruder would read the mislead information instead; capturing information with regards to identities of the intruder, by using the fingerprint identifier located on the dial pad of the phone; and capturing information with regards to activities by the intruder, by using the fingerprint identifier located on the control of the phone; when the phone is in a state that is considered safe by the owner, releasing the confidential information so that the owner is capable to re-access the confidential information, the state including when the intruder is found approaching away from the phone, by using the infrared transceivers; when the phone has been moved to a safe location, as detected by the location detector; and when the current time has reached to a time considered as safe by the owner.

In another embodiment, the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone based on detections by the fingerprint identifier located on a dial pad of the phone, the fingerprint identifier located on a control of the phone and the location detector, performing security measures, including protecting confidential information from the intruder, wherein the confidential information includes the content information of messages currently stored in the phone, the context information of messages currently stored in the phone, the specific content information currently stored in the phone, and the specific context information currently stored in the phone, protections including deleting the content information of messages currently stored in the phone with the corresponding mislead information; deleting the context information of messages currently stored in the phone; creating a set of new messages whose content is completely unrelated to the deleted messages so that the intruder would not be suspicious about the enablement of the security features when an empty message folder is found; capturing information with regards to identities of the intruder, by using the fingerprint identifier located on the dial pad of the phone; and capturing information with regards to activities by the intruder, by using the fingerprint identifier located on the control of the phone; when the phone is in a state that is considered safe by the owner, releasing the confidential information so that the owner is capable to re-access the confidential information, the state including when the intruder is found approaching away from the phone, by using the infrared transceivers; when the phone has been moved to a safe location, as detected by the location detector; and when the current time has reached to a time considered as safe by the owner.

Further, the identity information may also include fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone based on detections by the fingerprint identifier located on a dial pad of the phone, the fingerprint identifier located on a control of the phone and the location detector, performing security measures, including protecting confidential information from the intruder, wherein the confidential information includes the content information of messages currently stored in the phone, the context information of messages currently stored in the phone, the specific content information currently stored in the phone, and the specific context information currently stored in the phone, protections including deleting the content information of messages currently stored in the phone with the corresponding mislead information; deleting the context information of messages currently stored in the phone; creating a set of new messages whose content is completely unrelated to the deleted messages so that the intruder would not be suspicious about the enablement of the security features when an empty message folder is found; capturing information with regards to mental state of the intruder, as shown by photos taken by the camera; capturing information with regards to identities of the intruder, by using the camera; and capturing information with regards to activities by the intruder, by using the fingerprint identifier located on the control of the phone; when the phone is in a state that is considered safe by the owner, releasing the confidential information so that the owner is capable to re-access the confidential information, the state including when the intruder is found approaching away from the phone, by using the infrared transceivers; when the phone has been moved to a safe location, as detected by the location detector; and when the current time has reached to a time considered as safe by the owner.

### BRIEF DESCRIPTION OF THE DRAWINGS

FIG. 1 illustrates an exemplary system to handle intrusion-related issues.

### DETAILED DESCRIPTION

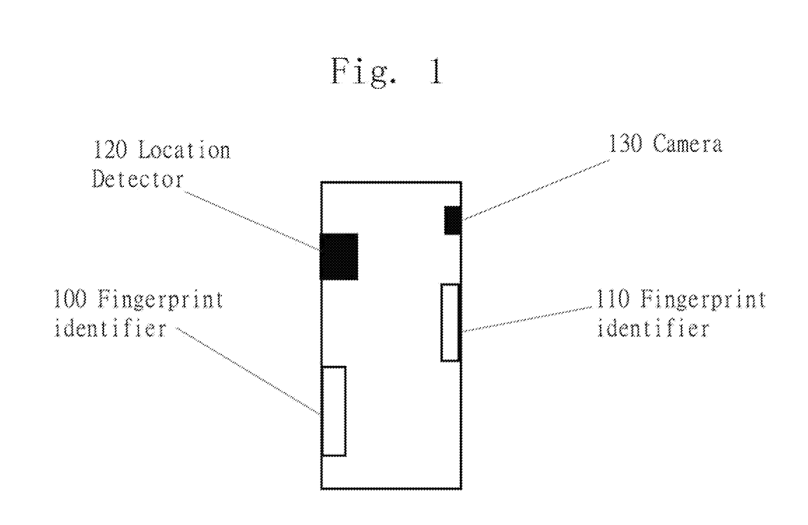

A phone configured to provide mislead information to intruders is provided. A number of implementations are provided. In FIG. 1, a fingerprint identifier is located on a control of the phone (100), wherein the dial pad includes an infrared transceiver that wirelessly detects whether a user's finger is approaching to the phone by temperature and distance of the user, the fingerprint identifier configured to keep track of fingerprints of the user when the user's finger is about to touch the dial pad. Further, a fingerprint identifier is located on a control of the phone (110), wherein the control includes an infrared transceiver that wirelessly detects whether the user's finger is approaching to the phone by temperature and distance of the user, the fingerprint identifier configured to keep track of frequency of attempt access by the user when the user's finger is about to touch the control. A location detector (120) is included in the phone, wherein the location detector (120) detects whether the phone should be entered to a secured mode by location; a camera (130) on the phone, wherein the camera (130) identifies the intruders; a processor in the phone; a memory in the phone storing instructions that cause the processor to execute a method, the method comprising as part of initialization, defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone, performing security measures, including protecting confidential information from the intruder, wherein the confidential information includes the content information of messages currently stored in the phone, the context information of messages currently stored in the phone, the specific content information currently stored in the phone, and the specific context information currently stored in the phone; capturing information with regards to identities of the intruder; and capturing information with regards to activities by the intruder; when the phone is in a state that is considered safe by the owner, releasing the confidential information so that the owner is capable to re-access the confidential information, the state including when the intruder is found approaching away from the phone; when the phone has been moved to a safe location; and when the current time has reached to a time considered as safe by the owner.

Alternatively, a phone may be configured to provide mislead information to intruders when intrusions occur. In which case, a fingerprint identifier located on a dial pad of the phone, wherein the dial pad includes an infrared transceiver that wirelessly detects whether a user's finger is approaching to the phone by temperature and distance of the user, the fingerprint identifier configured to keep track of fingerprints of the user when the user's finger is about to touch the dial pad; a fingerprint identifier located on a control of the phone, wherein the control includes an infrared transceiver that wirelessly detects whether the user's finger is approaching to the phone by temperature and distance of the user, the fingerprint identifier configured to keep track of frequency of attempt access by the user when the user's finger is about to touch the control; a location detector (120) in the phone, wherein the location detector (120) detects whether the phone should be entered to a secured mode by location; a camera (130) on the phone, wherein the camera (130) identifies the intruders; a processor in the phone; a memory in the phone storing instructions that cause the processor to execute a method, the method comprising, as part of initialization, defining security features of the phone by an owner of the phone, in terms of parameters, including current time and location of the phone; identity information with respect to allowed users to the phone.

In the exemplified example, the identity information may include fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone, performing security measures, including protecting confidential information from the intruder, wherein the confidential information includes the content information of messages currently stored in the phone, the context information of messages currently stored in the phone, the specific content information currently stored in the phone, and the specific context information currently stored in the phone, protections including swapping the specific content information of messages currently stored in the phone with the corresponding mislead information so that the intruder would instead read the mislead information; swapping the specific context information of messages currently stored in the phone with the corresponding mislead information so that the intruder would read the mislead information instead; capturing information with regards to identities of the intruder; and capturing information with regards to activities by the intruder; when the phone is in a state that is considered safe by the owner, releasing the confidential information so that the owner is capable to re-access the confidential information, the state including when the intruder is found approaching away from the phone; when the phone has been moved to a safe location; and when the current time has reached to a time considered as safe by the owner.

In yet another example, the phone may be configured to include a fingerprint identifier located on a dial pad of the phone, wherein the dial pad includes an infrared transceiver that wirelessly detects whether a user's finger is approaching to the phone by temperature and distance of the user, the fingerprint identifier configured to keep track of fingerprints of the user when the user's finger is about to touch the dial pad; a fingerprint identifier located on a control of the phone, wherein the control includes an infrared transceiver that wirelessly detects whether the user's finger is approaching to the phone by temperature and distance of the user, the fingerprint identifier configured to keep track of frequency of attempt access by the user when the user's finger is about to touch the control; a location detector (120) in the phone, wherein the location detector (120) detects whether the phone should be entered to a secured mode by location; a camera (130) on the phone, wherein the camera (130) identifies the intruders; a processor in the phone; a memory in the phone storing instructions that cause the processor to execute a method, the method comprising as part of initialization, defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone based on detections by the fingerprint identifier located on a dial pad of the phone, the fingerprint identifier located on a control of the phone and the location detector (120), performing security measures, including protecting confidential information from the intruder, wherein the confidential information includes the content information of messages currently stored in the phone, the context information of messages currently stored in the phone, the specific content information currently stored in the phone, and the specific context information currently stored in the phone, protections including swapping the specific content information of messages currently stored in the phone with the corresponding mislead information so that the intruder would instead read the mislead information; swapping the specific context information of messages currently stored in the phone with the corresponding mislead information so that the intruder would read the mislead information instead; capturing information with regards to identities of the intruder, by using the fingerprint identifier located on the dial pad of the phone; and capturing information with regards to activities by the intruder, by using the fingerprint identifier located on the control of the phone; when the phone is in a state that is considered safe by the owner, releasing the confidential information so that the owner is capable to re-access the confidential information, the state including when the intruder is found approaching away from the phone, by using the infrared transceivers; when the phone has been moved to a safe location, as detected by the location detector (120); and when the current time has reached to a time considered as safe by the owner.

Moreover, the location detector (120) may further be modified in the phone, in which the location detector (120) detects whether the phone should be entered to a secured mode by location; a camera (130) on the phone, wherein the camera (130) identifies the intruders; a processor in the phone; a memory in the phone storing instructions that cause the processor to execute a method, the method comprising as part of initialization, defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone based on detections by the fingerprint identifier located on a dial pad of the phone, the fingerprint identifier located on a control of the phone and the location detector (120), performing security measures, including; protecting confidential information from the intruder, wherein the confidential information includes the content information of messages currently stored in the phone, the context information of messages currently stored in the phone, the specific content information currently stored in the phone, and the specific context information currently stored in the phone, protections including deleting the content information of messages currently stored in the phone with the corresponding mislead information; deleting the context information of messages currently stored in the phone; creating a set of new messages whose content is completely unrelated to the deleted messages so that the intruder would not be suspicious about the enablement of the security features when an empty message folder is found; capturing information with regards to identities of the intruder, by using the fingerprint identifier located on the dial pad of the phone; and capturing information with regards to activities by the intruder, by using the fingerprint identifier located on the control of the phone; when the phone is in a state that is considered safe by the owner, releasing the confidential information so that the owner is capable to re-access the confidential information, the state including when the intruder is found approaching away from the phone, by using the infrared transceivers; when the phone has been moved to a safe location, as detected by the location detector (120); and when the current time has reached to a time considered as safe by the owner.

Even further, the location detector (120) may detect whether the phone should be entered to a secured mode by location. A camera (130) may be included on the phone, wherein the camera (130) identifies the intruders. Other components may be included, including a processor in the phone; a memory in the phone storing instructions that cause the processor to execute a method, the method comprising as part of initialization, defining security features of the phone by an owner of the phone, in terms of parameters, including current time and location of the phone; identity information with respect to allowed users to the phone, wherein the identity information includes fingerprints and body temperature of the allowed users; content information of messages currently stored in the phone, in text and graphics; context information regarding the messages, including time, callers, and phone numbers associated with the messages; mislead information corresponding to specific content information currently stored in the phone, so that certain content information would be changed to the mislead information when intrusions occur; and mislead information corresponding to specific context information currently stored in the phone, so that certain context information would be changed to the mislead information when intrusions occur; enabling the security features to monitor if any intruders are approaching to the phone; when an intruder is found approaching to the phone based on detections by the fingerprint identifier located on a dial pad of the phone, the fingerprint identifier located on a control of the phone and the location detector (120), performing security measures, including protecting confidential information from the intruder, wherein the confidential information includes the content information of messages currently stored in the phone, the context information of messages currently stored in the phone, the specific content information currently stored in the phone, and the specific context information currently stored in the phone, protections including deleting the content information of messages currently stored in the phone with the corresponding mislead information; deleting the context information of messages currently stored in the phone; creating a set of new messages whose content is completely unrelated to the deleted messages so that the intruder would not be suspicious about the enablement of the security features when an empty message folder is found; capturing information with regards to mental state of the intruder, as shown by photos taken by the camera (130); capturing information with regards to identities of the intruder, by using the camera (130); and capturing information with regards to activities by the intruder, by using the fingerprint identifier located on the control of the phone; when the phone is in a state that is considered safe by the owner, releasing the confidential information so that the owner is capable to re-access the confidential information, the state including when the intruder is found approaching away from the phone, by using the infrared transceivers; when the phone has been moved to a safe location, as detected by the location detector (120); and when the current time has reached to a time considered as safe by the owner.

What is claimed is:

1. A phone configured to provide mislead information to intruders when intrusions occur, comprising:
a fingerprint identifier located on a dial pad of the phone, wherein the dial pad includes an infrared transceiver that wirelessly detects whether a user's finger is approaching to the phone by temperature and distance of the user, the fingerprint identifier configured to keep track of fingerprints of the user when the user's finger is about to touch the dial pad;
a fingerprint identifier located on a control of the phone, wherein the control includes an infrared transceiver that wirelessly detects whether the user's finger is approaching to the phone by temperature and distance of the user, the fingerprint identifier configured to keep track of frequency of attempt access by the user when the user's finger is about to touch the control;
a location detector in the phone, wherein the location detector detects whether the phone should be entered to a secured mode by location;
a camera on the phone, wherein the camera identifies the intruders;
a processor in the phone; and
a memory in the phone storing instructions that cause the processor to execute a method.

2. The phone of claim 1, wherein the method comprises:
as part of initialization, defining security features of the phone by an owner of the phone, in terms of parameters, including:
current time and location of the phone;
identity information with respect to allowed users to the phone, wherein the identity information includes fingerprints and body temperature of the allowed users;
content information of messages currently stored in the phone, in text and graphics;
context information regarding the messages, including time, callers, and phone numbers associated with the messages;
mislead information corresponding to specific content information currently stored in the phone, so that certain content information would be changed to the mislead information when intrusions occur; and
mislead information corresponding to specific context information currently stored in the phone, so that certain context information would be changed to the mislead information when intrusions occur;
enabling the security features to monitor if any intruders are approaching to the phone;
when an intruder is found approaching to the phone, performing security measures, including;
protecting confidential information from the intruder, wherein the confidential information includes the content information of messages currently stored in the phone, the context information of messages currently stored in the phone, the specific content information currently stored in the phone, and the specific context information currently stored in the phone;
capturing information with regards to identities of the intruder; and
capturing information with regards to activities by the intruder; and
when the phone is in a state that is considered safe by the owner, releasing the confidential information so that the owner is capable to re-access the confidential information, the state including:
when the intruder is found approaching away from the phone;
when the phone has been moved to a safe location; and
when the current time has reached to a time considered as safe by the owner.

3. The phone of claim 1, wherein the method comprises:
as part of initialization, defining security features of the phone by an owner of the phone, in terms of parameters, including:
current time and location of the phone;
identity information with respect to allowed users to the phone, wherein the identity information includes fingerprints and body temperature of the allowed users;
content information of messages currently stored in the phone, in text and graphics;
context information regarding the messages, including time, callers, and phone numbers associated with the messages;
mislead information corresponding to specific content information currently stored in the phone, so that certain content information would be changed to the mislead information when intrusions occur; and
mislead information corresponding to specific context information currently stored in the phone, so that certain context information would be changed to the mislead information when intrusions occur;
enabling the security features to monitor if any intruders are approaching to the phone;
when an intruder is found approaching to the phone, performing security measures, including;
protecting confidential information from the intruder, wherein the confidential information includes the content information of messages currently stored in the phone, the context information of messages currently stored in the phone, the specific content information currently stored in the phone, and the specific context information currently stored in the phone, protections including
swapping the specific content information of messages currently stored in the phone with the corresponding mislead information so that the intruder would instead read the mislead information;
swapping the specific context information of messages currently stored in the phone with the corresponding mislead information so that the intruder would read the mislead information instead;
capturing information with regards to identities of the intruder; and
capturing information with regards to activities by the intruder;
when the phone is in a state that is considered safe by the owner, releasing the confidential information so that the owner is capable to re-access the confidential information, the state including:
when the intruder is found approaching away from the phone;
when the phone has been moved to a safe location; and
when the current time has reached to a time considered as safe by the owner.

4. The phone of claim 1, wherein the method comprises:
as part of initialization, defining security features of the phone by an owner of the phone, in terms of parameters, including:
current time and location of the phone;
identity information with respect to allowed users to the phone, wherein the identity information includes fingerprints and body temperature of the allowed users;
content information of messages currently stored in the phone, in text and graphics;
context information regarding the messages, including time, callers, and phone numbers associated with the messages;
mislead information corresponding to specific content information currently stored in the phone, so that certain content information would be changed to the mislead information when intrusions occur; and
mislead information corresponding to specific context information currently stored in the phone, so that certain context information would be changed to the mislead information when intrusions occur;
enabling the security features to monitor if any intruders are approaching to the phone;
when an intruder is found approaching to the phone based on detections by the fingerprint identifier located on a dial pad of the phone, the fingerprint identifier located on a control of the phone and the location detector, performing security measures, including;
protecting confidential information from the intruder, wherein the confidential information includes the content information of messages currently stored in the phone, the context information of messages currently stored in the phone, the specific content information currently stored in the phone, and the specific context information currently stored in the phone, protections including
swapping the specific content information of messages currently stored in the phone with the corresponding mislead information so that the intruder would instead read the mislead information;
swapping the specific context information of messages currently stored in the phone with the corresponding mislead information so that the intruder would read the mislead information instead;
capturing information with regards to identities of the intruder, by using the fingerprint identifier located on the dial pad of the phone; and
capturing information with regards to activities by the intruder, by using the fingerprint identifier located on the control of the phone;
when the phone is in a state that is considered safe by the owner, releasing the confidential information so that the owner is capable to re-access the confidential information, the state including:
when the intruder is found approaching away from the phone, by using the infrared transceivers;
when the phone has been moved to a safe location, as detected by the location detector; and
when the current time has reached to a time considered as safe by the owner.

5. The phone of claim 1, wherein the method comprises:
as part of initialization, defining security features of the phone by an owner of the phone, in terms of parameters, including:
current time and location of the phone;
identity information with respect to allowed users to the phone, wherein the identity information includes fingerprints and body temperature of the allowed users;
content information of messages currently stored in the phone, in text and graphics;
context information regarding the messages, including time, callers, and phone numbers associated with the messages;
mislead information corresponding to specific content information currently stored in the phone, so that certain content information would be changed to the mislead information when intrusions occur; and
mislead information corresponding to specific context information currently stored in the phone, so that certain context information would be changed to the mislead information when intrusions occur;
enabling the security features to monitor if any intruders are approaching to the phone;
when an intruder is found approaching to the phone based on detections by the fingerprint identifier located on a dial pad of the phone, the fingerprint identifier located on a control of the phone and the location detector, performing security measures, including;
protecting confidential information from the intruder, wherein the confidential information includes the content information of messages currently stored in the phone, the context information of messages currently stored in the phone, the specific content information currently stored in the phone, and the specific context information currently stored in the phone, protections including
deleting the content information of messages currently stored in the phone with the corresponding mislead information;
deleting the context information of messages currently stored in the phone;
creating a set of new messages whose content is completely unrelated to the deleted messages so that the intruder would not be suspicious about the enablement of the security features when an empty message folder is found;
capturing information with regards to identities of the intruder, by using the fingerprint identifier located on the dial pad of the phone; and
capturing information with regards to activities by the intruder, by using the fingerprint identifier located on the control of the phone;
when the phone is in a state that is considered safe by the owner, releasing the confidential information so that the owner is capable to re-access the confidential information, the state including:
when the intruder is found approaching away from the phone, by using the infrared transceivers;
when the phone has been moved to a safe location, as detected by the location detector; and
when the current time has reached to a time considered as safe by the owner.

6. The phone of claim 1, wherein the method comprises:
as part of initialization, defining security features of the phone by an owner of the phone, in terms of parameters, including:
current time and location of the phone;
identity information with respect to allowed users to the phone, wherein the identity information includes fingerprints and body temperature of the allowed users;
content information of messages currently stored in the phone, in text and graphics;
context information regarding the messages, including time, callers, and phone numbers associated with the messages;
mislead information corresponding to specific content information currently stored in the phone, so that certain content information would be changed to the mislead information when intrusions occur; and
mislead information corresponding to specific context information currently stored in the phone, so that certain context information would be changed to the mislead information when intrusions occur;
enabling the security features to monitor if any intruders are approaching to the phone;
when an intruder is found approaching to the phone based on detections by the fingerprint identifier located on a dial pad of the phone, the fingerprint identifier located on a control of the phone and the location detector, performing security measures, including;
protecting confidential information from the intruder, wherein the confidential information includes the content information of messages currently stored in the phone, the context information of messages currently stored in the phone, the specific content information currently stored in the phone, and the specific context information currently stored in the phone, protections including
deleting the content information of messages currently stored in the phone with the corresponding mislead information;
deleting the context information of messages currently stored in the phone;
creating a set of new messages whose content is completely unrelated to the deleted messages so that the intruder would not be suspicious about the enablement of the security features when an empty message folder is found;
capturing information with regards to mental state of the intruder, as shown by photos taken by the camera;
capturing information with regards to identities of the intruder, by using the camera; and
capturing information with regards to activities by the intruder, by using the fingerprint identifier located on the control of the phone;
when the phone is in a state that is considered safe by the owner, releasing the confidential information so that the owner is capable to re-access the confidential information, the state including:
when the intruder is found approaching away from the phone, by using the infrared transceivers;
when the phone has been moved to a safe location, as detected by the location detector; and
when the current time has reached to a time considered as safe by the owner.
